(19) United States
(12) Patent Application Publication
(10) Pub. No.: US 2012/0248392 A1
(43) Pub. Date: Oct. 4, 2012

(54) Fiber Optic Enclosure Assemblies and Methods for Forming and Using the Same

(75) Inventors: Barry Wayne Allen, Siler City, NC (US); Julian Mullaney, Raleigh, NC (US); Gary W. Adams, Holly Springs, NC (US)

(73) Assignee: TYCO ELECTRONICS CORPORATION

(21) Appl. No.: 13/074,829

(22) Filed: Mar. 29, 2011

(51) Int. Cl. G02B 6/46; B29C 65/70; B29C 45/14; B23P 17/04

(52) U.S. Cl. 254/134.3 R; 29/428; 264/249; 264/259

(57) ABSTRACT

A fiber optic enclosure assembly for protecting an optical fiber includes a tubular body member, an end member and a coupling member. The tubular body member has first and second opposed ends and defines an interior body passage to receive a portion of the optical fiber. The end member is separately formed from the body member and is mounted on the first end thereof. The coupling member is directly bonded to each of the body member and the end member to secure the end member to the body member and to form an environmental seal between the end member and the body member. The body member and the end member are formed of dissimilar materials, the material of the body member being more flexible than the material of the end member. The coupling member is formed of a material capable of forming a secure bond with both the material of the body member and the material of the end member.

### FIELD OF THE INVENTION

The present invention relates to optic fibers and, more particularly, to fiber optic enclosures and methods for deploying fiber optic cables.

### BACKGROUND OF THE INVENTION

An extensive infrastructure supporting telecommunication has been developed, traditionally based upon copper wire connections between individual subscribers and telecommunications company network distribution points. More recently, much of the telecommunications network infrastructure is being extended or replaced with an optical fiber based communications network infrastructure. The carrying capacity and communication rate capabilities of such equipment may exceed that provided by conventional copper wired systems. As such, fiber optic cables are widely used for telecommunications applications where high information capacity, noise immunity and other advantages of optical fibers may be exploited. Fiber cable architectures are emerging for connecting homes and/or business establishments, via optical fibers, to a central location.

### SUMMARY OF THE INVENTION

According to embodiments of the present invention, a fiber optic enclosure assembly for protecting an optical fiber includes a tubular body member, an end member and a coupling member. The tubular body member has first and second opposed ends and defines an interior body passage to receive a portion of the optical fiber. The end member is separately formed from the body member and is mounted on the first end thereof. The coupling member is directly bonded to each of the body member and the end member to secure the end member to the body member and to form an environmental seal between the end member and the body member. The body member and the end member are formed of dissimilar materials, the material of the body member being more flexible than the material of the end member. The coupling member is formed of a material capable of forming a secure bond with both the material of the body member and the material of the end member.

According to method embodiments of the present invention, a method for forming a fiber optic enclosure assembly for protecting an optical fiber includes: providing a tubular body member having first and second opposed ends and defining an interior body passage to receive a portion of the optical fiber; forming an end member separately from the body member; mounting the end member on the first end of the body member; and directly bonding a coupling member to each of the body member and the end member to secure the end member to the body member and to form an environmental seal between the end member and the body member. The body member and the end member are formed of dissimilar materials, the material of the body member being more flexible than the material of the end member. The coupling member is formed of a material capable of forming a secure bond with both the material of the body member and the material of the end member.

According to further method embodiments of the present invention, a method for deploying a fiber optic cable in an environment, the fiber optic cable including an optical fiber includes providing a fiber optic enclosure assembly including: a tubular body member having first and second opposed ends and defining an interior body passage to receive a portion of the optical fiber; an end member separately formed from the body member and mounted on the first end thereof; and a coupling member directly bonded to each of the body member and the end member to secure the end member to the body member and to form an environmental seal between the end member and the body member; wherein the body member and the end member are formed of dissimilar materials, the material of the body member being more flexible than the material of the end member; and wherein the coupling member is formed of a material capable of forming a secure bond with both the material of the body member and the material of the end member. The method further includes: installing the fiber optic enclosure assembly on the fiber optic cable such that a portion of the optical fiber is disposed in the interior body passage; and pulling the fiber optic enclosure assembly to draw the fiber optic cable through the environment.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a rear perspective view of a protected cable assembly according to embodiments of the present invention.

FIG. 2 is an exploded, rear perspective of the protected cable assembly of FIG. 1.

FIG. 3 is a cross-sectional view of the protected cable assembly of FIG. 1 taken along the line 3-3 of FIG. 1.

FIG. 4 is a fragmentary, cross-sectional view of the protected cable assembly of FIG. 1 taken along the line 3-3 of FIG. 1.

FIG. 5 is a rear perspective view of a base end member forming a part of the protected cable assembly of FIG. 1.

FIG. 6 is a front perspective view of a lead end member forming a part of the protected cable assembly of FIG. 1.

FIG. 7 is a rear perspective view of a coupling member forming a part of the protected cable assembly of FIG. 1.

FIG. 8 is a front perspective view of a cable connector member forming a part of the protected cable assembly of FIG. 1.

FIG. 9 is a fragmentary, enlarged, cross-sectional view of a base end of a cover forming a part of the protected cable assembly of FIG. 1.

FIG. 10 is a fragmentary, enlarged, cross-sectional view of a lead end of the cover of FIG. 9.

FIG. 11 is a cross-sectional view of a mold apparatus for forming the cover of FIG. 9.

FIG. 12 is a schematic view of an environment wherein the protected cable assembly of FIG. 1 is being deployed.

### DETAILED DESCRIPTION OF THE EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

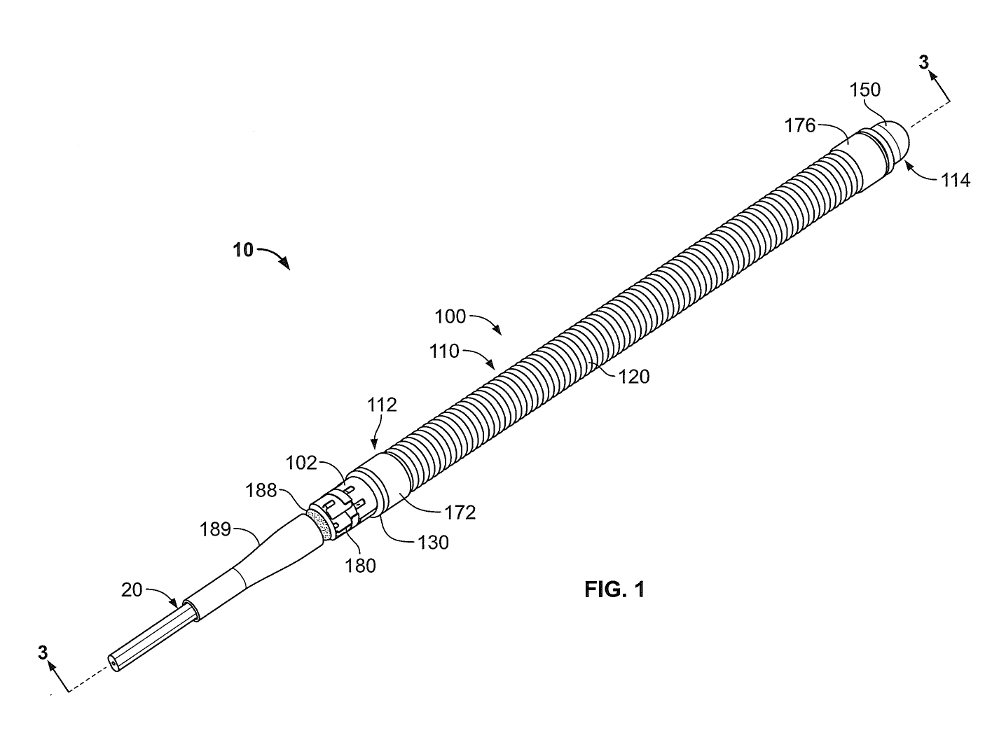

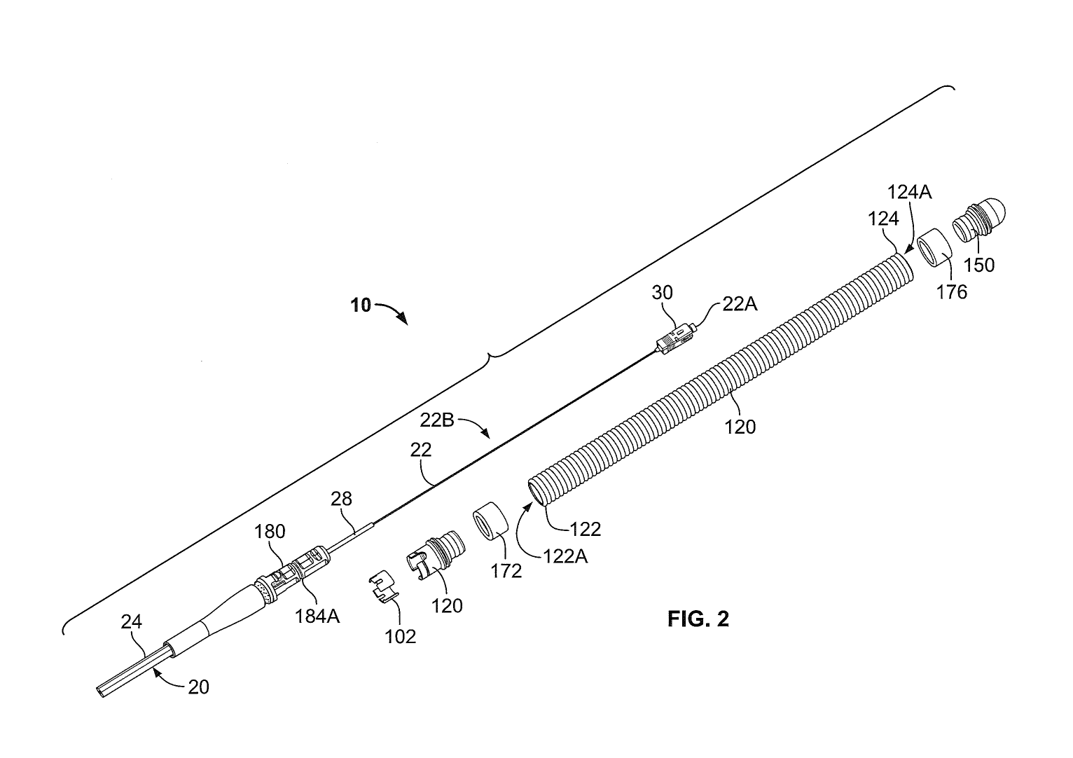

With reference to FIGS. 1-10, a fiber optic enclosure assembly 100 according to embodiments of the present invention is shown therein. The enclosure assembly 100 may be used to protect an optical fiber 22 and/or a pre-installed fiber optic connector 30 of a fiber optic cable 20. More particularly, the enclosure assembly 100 can be removably mounted on an end of the cable 20 to form a protected cable assembly 10 as shown in FIGS. 1-4. According to some embodiments, the enclosure assembly 100 is mounted on the end of the cable 20 to protect the terminal end of the optical fiber 22 and/or the connector 30 as the cable 20 is routed (e.g., drawn through conduits or the like) from a first fiber optic terminal to a second fiber optic terminal. At least a portion of the enclosure assembly 100 can be thereafter removed from the end of the cable 20 to expose the terminal end 22A of the optical fiber 22 and/or the fiber optic connector 30 to permit the fiber 22 to be operably connected at the second terminal.

The fiber optic cable 20 may be of any suitable construction, such as fiber optic cables of known or conventional design. The exemplary cable 20 as illustrated includes an optical fiber or waveguide configured to enable transmission of optical communication signals therethrough. The cable 20 further includes a buffer tube 28 surrounding the fiber 22 and a polymeric jacket 24 surrounding the buffer tube 28. A strength member 26 is also provided in the jacket 24. It will be appreciated from the description herein that the cable 20 may include multiple optical fibers, buffer tubes and/or strength members. A section 22B of the fiber 22 is stripped of the jacket 24 and, in part, the buffer tube 28. The connector 30 may be pre-installed on the fiber 22 at the fiber terminal end 22A.

Turning to the enclosure assembly 100 in more detail, the enclosure assembly 100 includes a cover 110, a cable connector member 180 and a lock member clip 102. As discussed below, the cable connector member 180 can be secured (e.g., permanently) to the cable 20 and the lock clip 102 can be used to removably secure the cover 110 to the cable connector member 180 and thereby to the cable 20. The stripped section 22B and the connector 30 are contained in a chamber 104 defined by the cover 110.

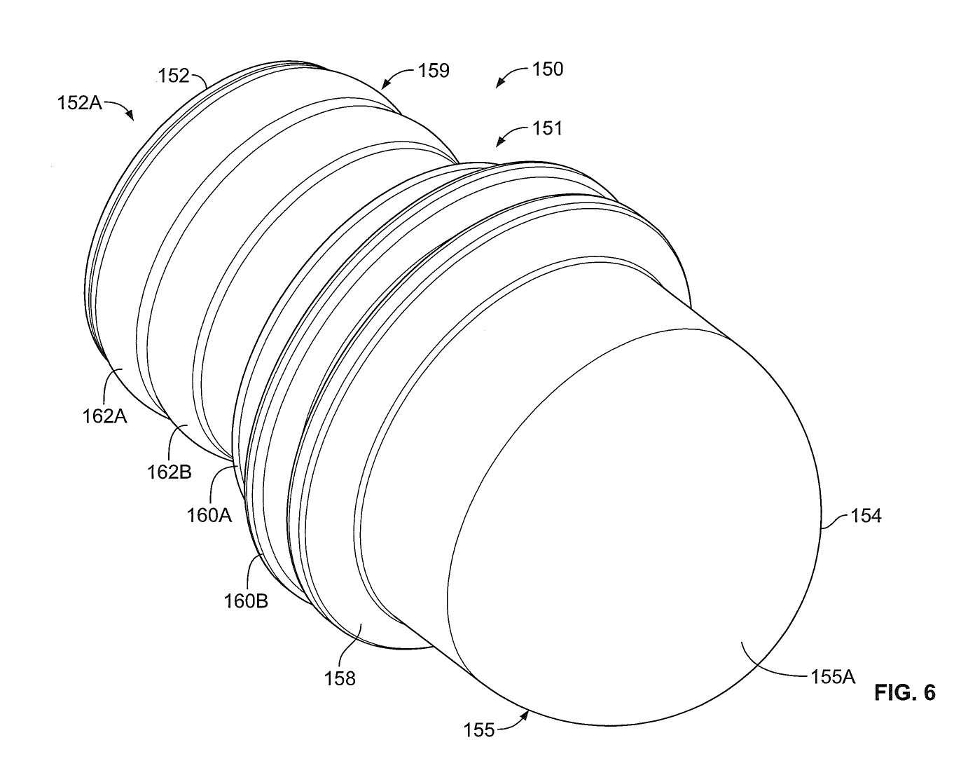

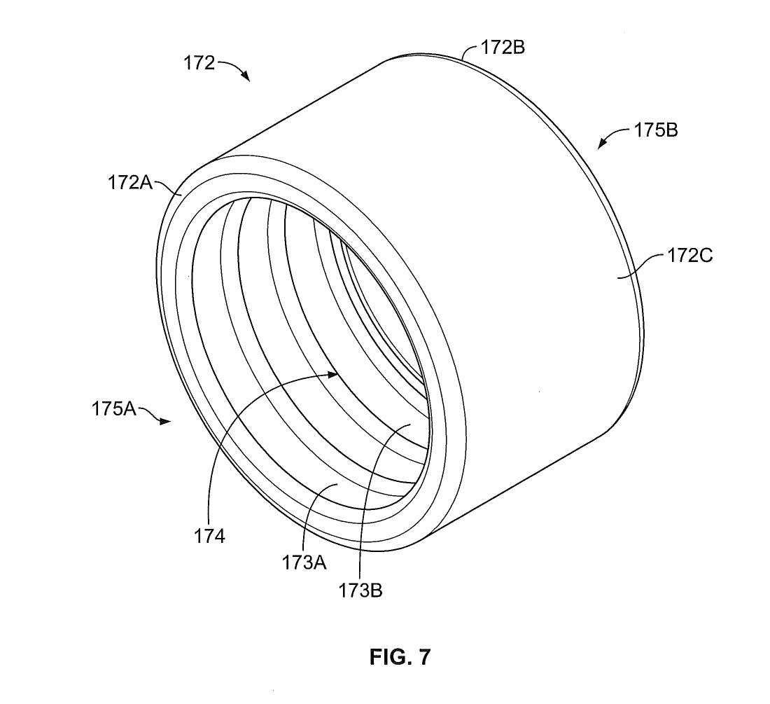

The cover 110 has a first or base end 112 and an opposing second or lead end 114 (FIG. 1). The cover 110 includes a tubular body member 120, a base end member 130 (FIG. 5), a lead end member 150 (FIG. 6), a base coupling member 172 (FIG. 7), and a lead coupling member 176.

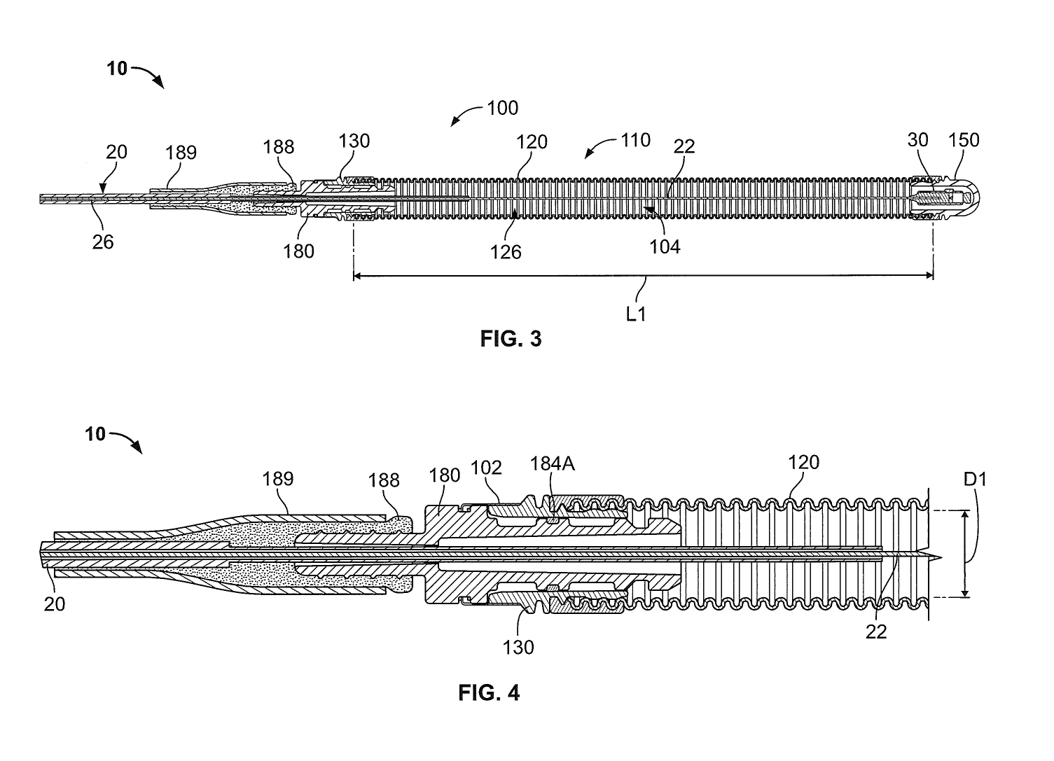

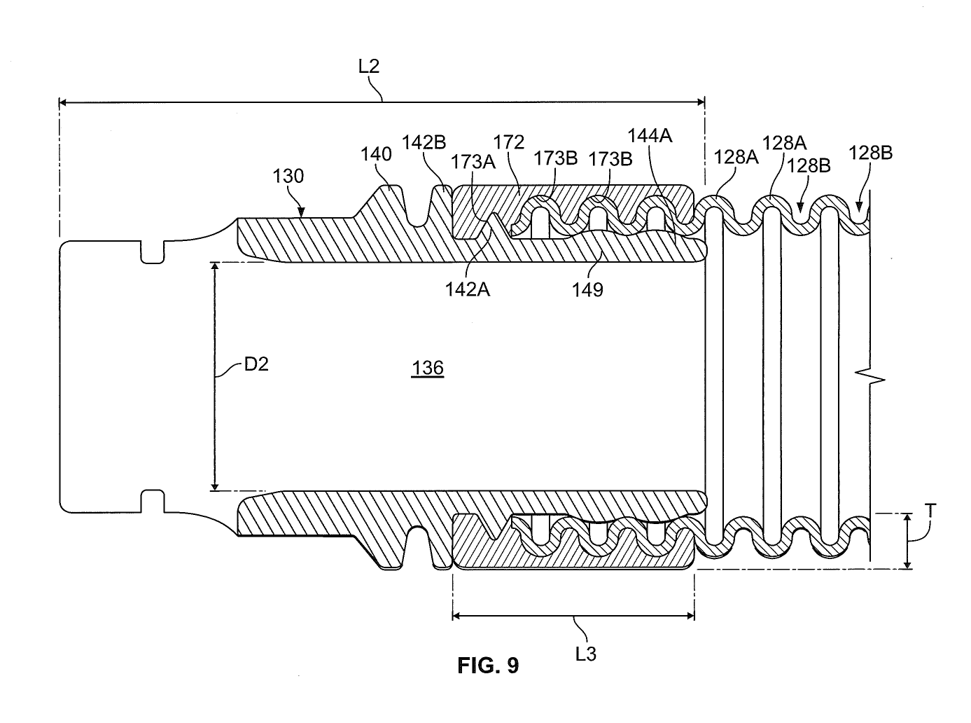

The tubular body member 120 has a base end 122 and an opposing lead end 124. The body member 120 defines a through passage 126 (FIG. 3) terminating and communicating with a base end opening 122A and a lead end opening 124A. The body member 120 is corrugated or contoured to define alternating annular ribs 128A and grooves 128B (FIG. 9).

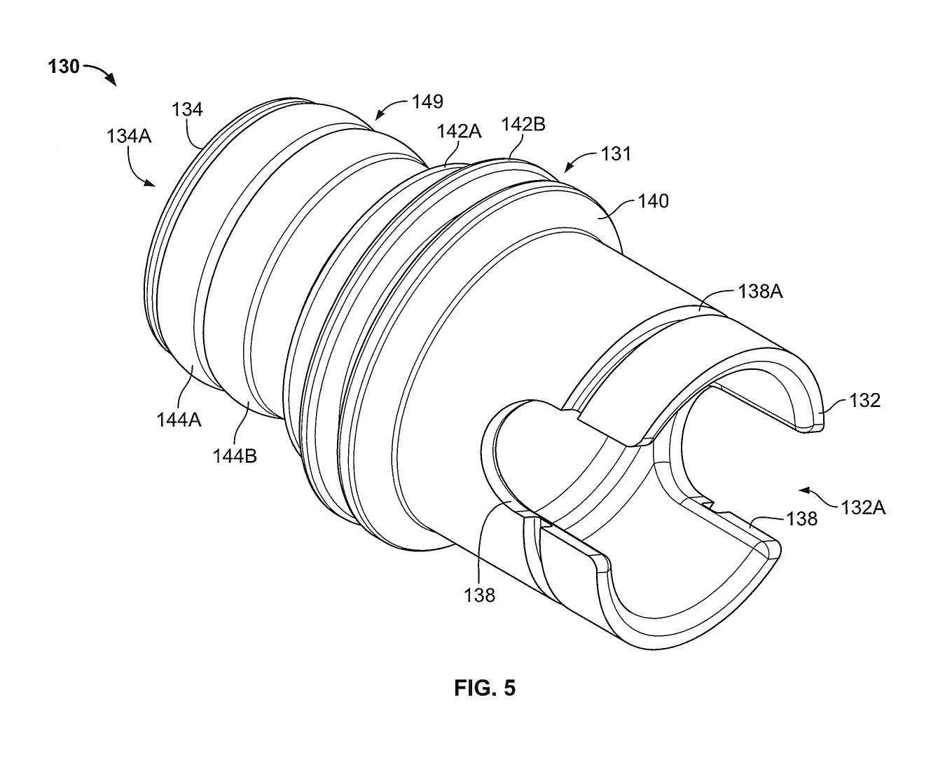

According to some embodiments, the length L1 (FIG. 3) of the body member 120 is in the range of from about 15 to 90 cm and, in some embodiments, from about 20 to 40 cm. According to some embodiments, the inner diameter D1 (FIG. 4) of the body member 120 is in the range of from about 11 to 30 mm and, in some embodiments, from about 15 to 19 mm. According to some embodiments, the pitch or lengthwise distance between the centers of adjacent ribs 128A is in the range of from about 3.4 to 3.5 mm.

The body member 120 may be formed of any suitable material. According to some embodiments, the body member 120 is formed of a polymeric material and, in some embodiments, the polymeric material includes at least one of polyolefin (such as high density polyethylene, low density polyethylene, poly propylene and the like), thermoplastic vulcanizate, thermoplastic elastomer, polyester, polyurethane, flexibilized polyamide, flexible poly(vinyl chloride), and polymer containing poly dimethyl siloxane. According to some embodiments, the body member 120 is formed of polyolefin, polyethylene and/or polypropylene.

According to some embodiments, the flexural modulus of the body member material is in the range of from about 10,000 psi to 200,000 psi and, in some embodiments, between about 15,000 psi and 50,000 psi. According to some embodiments, the hardness of the body member material is in the range of from about 30 shore A to 90 shore D and, in some embodiments, between about 30 shore D and 90 shore D.

In alternative embodiments, the body member 120 may have a relatively smooth (e.g., non-corrugated) outer surface and/or inner surface.

The body member 120 may be formed by any suitable method. According to some embodiments, the body member 120 is extruded as a tube and cut to length.

With reference to FIG. 5, the base end member 130 includes an annular body 131 having a mount or insert section 149, a base end 132 and a lead end 134. An entry passage 136 extends fully through the body 131 and communicates with opposed base and lead end openings 132A and 134A. Interlock slots 138 (having latch grooves 138A) are defined in the body member 131 at the base end 132 and annular ribs 140, 142A, 142B, 144A, 144B are defined in the outer surface of the body 131.

The base end member 130 may be formed of any suitable material. According to some embodiments, the material of the base end member 130 has a greater hardness than that of the material from which the body member 120 is formed. According to some embodiments, the base end member 130 has a hardness that is at least 25 percent greater than the hardness of the body member 120 and, in some embodiments, between about 60 and 100 percent greater. According to some embodiments, the material of the tubular body member 120 has less rigidity than the material of the base end member 130. According to some embodiments, the flexural modulus of the body member 120 material is 50 percent less than the flexural modulus of the base end member 130 material.

According to embodiments of the present invention, the base end member 130 is formed of a polymeric material, according to some embodiments a thermoplastic material, and according to some embodiments, a polymeric material including at least one of polycarbonate, polyester, glass reinforced polymer, polyolefin, acrylonitrile butadiene, styrene copolymer and/or an alloy thereof, polyamide, liquid crystalline polymer (such as XYDAR from Solvay), polyetherimide, polyphenylene sulfide, poly oxymethylene and copolymers thereof, poly ether ether ketone, polysulfone, and fluoropolymer (such as polyvinylidene fluoride). According to some embodiments, the end member 130 is formed of polycarbonate/polybutylene terephthalate alloy, and/or polyetherimide (such as ULTEM).

The base end member 130 may be formed using any suitable technique. Because of the configuration and/or material of the base end member 130, it may not be possible, desirable or cost-effective to form the base end member 130 by extrusion. According to some embodiments, the base end member 130 is formed by molding or casting. According to some embodiments, the base end member 130 is injection molded.

According to some embodiments, the length L2 (FIG. 9) of the base member 130 is in the range of from about 36 to 38 mm. According to some embodiments, the inner diameter D2 (FIG. 9) of the base end member 130 is in the range of from about 14 to 15 mm. According to some embodiments, the outer diameter of the base end member 130 is substantially the same as the inner diameter D1 of the body member 120.

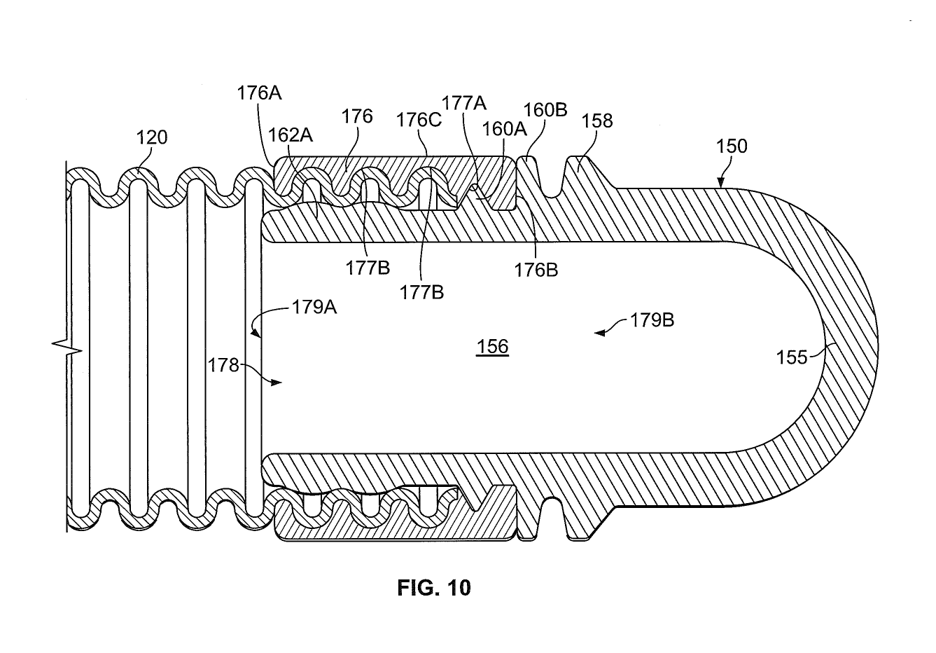

The lead end member 150 (FIG. 6) includes a body 151 having a mount or insert section 159, a base end 152 and an opposing lead end 154. A cavity 156 (FIG. 10) is defined in the body 151. The cavity 156 is closed by an end wall 155 on the lead end 154 and communicates with an opening 152A at the base end 152. The end wall 155 has a relatively smooth dome-shaped outer surface 155A. Annular ribs 158, 160A, 160B, 162A, 162B are defined on the outer surface of the body 151.

The lead end member 150 may be formed of the same materials and in the same manner as discussed above with regard to the base end member 130.

The base coupling member 172 (FIG. 7) has a base edge 172A, an opposing lead edge 172B, and an outer surface 172C. The base coupling member 172 defines a through passage 174 communicating with opposed end openings 175A and 175B. A series of annular grooves 173A, 173B are defined in the inner surface defining the passage 174. According to some embodiments, the outer surface 172C is relatively smooth.

The base coupling member 172 may be formed of any suitable material capable of forming a secure bond with both the material of the body member 120 and the material of the end members 130, 150. According to some embodiments, the base coupling member 172 is formed of polymer containing polydimethyl siloxane (such as liquid injection molded silicone resin), thermoplastic elastomer, thermoplastic vulcanizate, low density polyethylene, polyethylene block copolymer (such as INFUSE from Dow Chemical), polypropylene copolymer, and/or flexible poly(vinyl chloride). According to some embodiments, the coupling member 172 is formed of thermoplastic vulcanizate. According to some embodiments, the material of the base coupling member 172 includes bonding additives that improve bonding with the body member 120 and/or the end members 130, 150.

According to some embodiments, the base coupling member 172 has a length L3 (FIG. 9) in the range of from about 14 to 15 mm. According to some embodiments, the base coupling member 172 has a thickness T (FIG. 9) in the range of from about 3 to 3.5 mm.

The base coupling member 172 may be molded, as discussed in more detail hereinbelow.

The lead coupling member 176 (FIG. 10) has a base edge 176A, a lead edge 176B, and an outer surface 176C (which may be smooth) and defines a through passage 178 communicating with end openings 179A, 179B. A series of annular grooves 177A, 177B are defined in the inner wall of the passage 178. The lead coupling member 176 may be formed of the same material, in the same manner, and of the same dimensions as discussed herein with regard to the base coupling member 172.

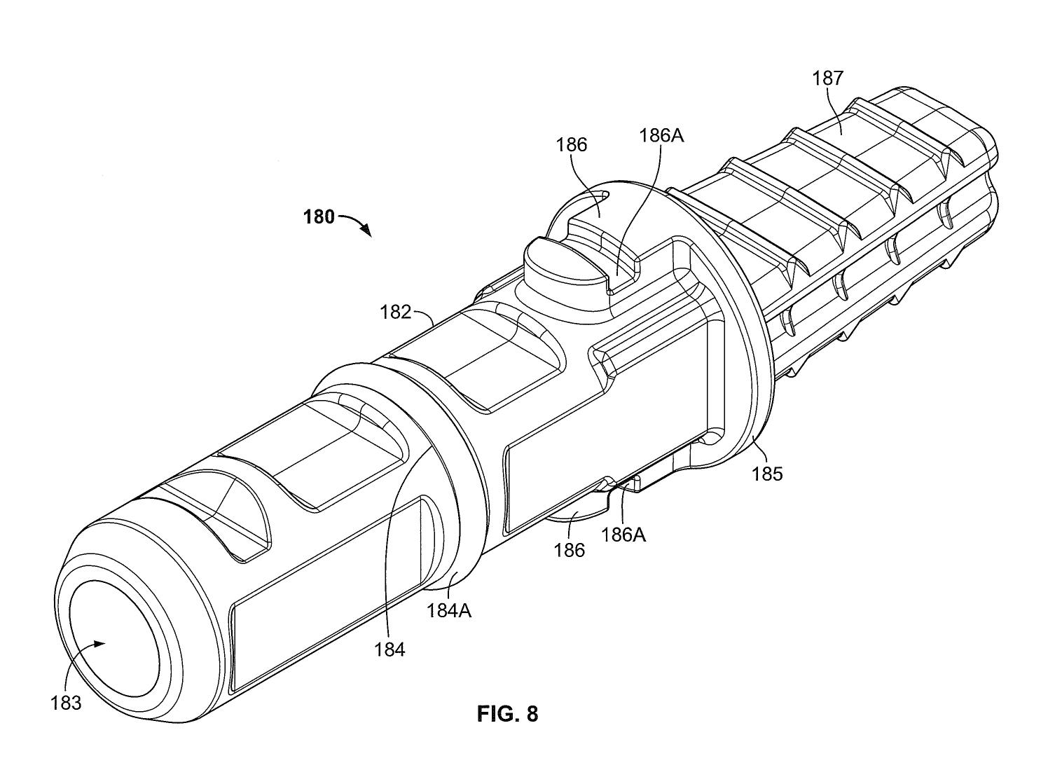

The cable connector member 180 (FIG. 8) includes a body 182 defining a through passage 183, an annular O-ring groove 184, a shoulder 185, key features or tabs 186, lock clip slots 186A, and an anchor section 187. An O-ring 184A is mounted in the O-ring groove 184. The cable connector member 180 may be formed of the same materials and in the same manner as discussed above with regard to the base end member 130.

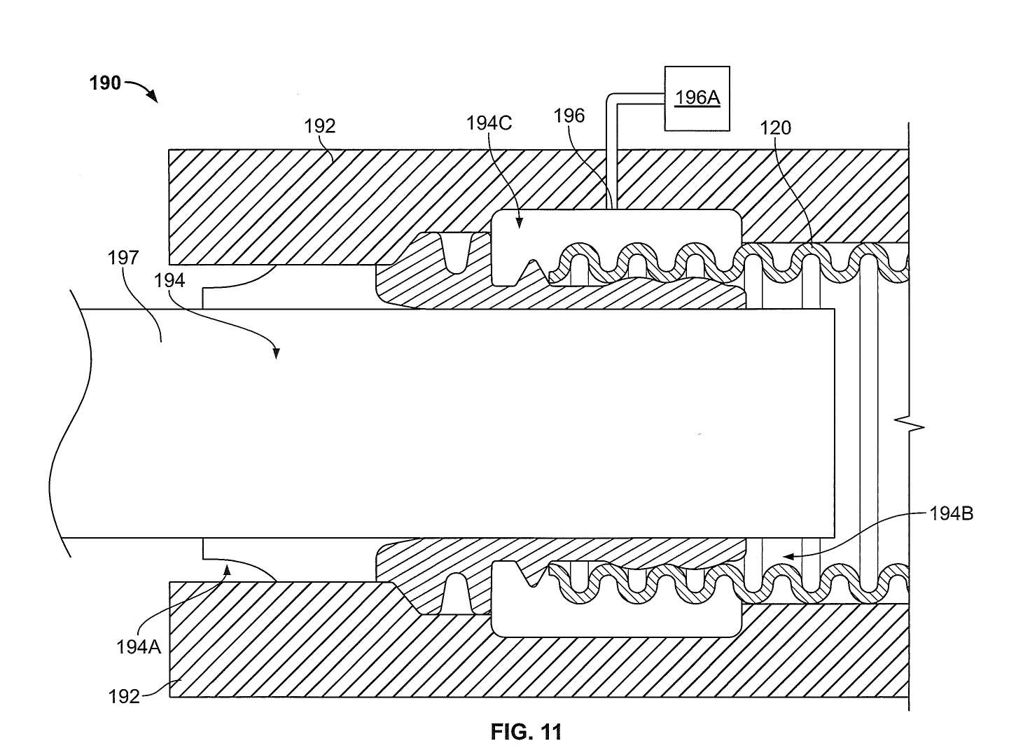

According to some embodiments, the cover 110 can be formed as follows. The body member 120, the base end member 130 and the lead end member 150 are formed as described above as individual discrete members. The insert section 149 of the base end member 130 is inserted into the base end 122 of the body member 120. A mandrel 197 (FIG. 11) may be inserted through the base end member 130 and the body member 120.

The base end member 130 and the body member 120 are then placed in a mold apparatus 190 (FIG. 11) including mold plates 192. The mold plates 192 collectively define a mold cavity including (as contiguous subcavities) an end member recess cavity 194A, a body member receiving cavity 194B, and a coupling member forming cavity 194C. Molten material for forming the coupling member 172 is injected from a material supply 196A into the cavity 194C via an injection port 196. Upon cooling of the material in the cavity 194C, the base coupling member 172 is thereby formed.

The coupling member 172 is thus formed by injection molding and, more particularly, insert injection molding about and directly onto (i.e., in intimate contact with) each of the base end member 130 and the body member 120. As a result of this and the selection of materials for the components 120, 130 and 172, the coupling member 172 directly bonds to each of the end member 130 and the body member 120. According to some embodiments, the coupling member 172 directly chemically bonds to each member 120, 130. According to some embodiments, the coupling member 172 directly physically bonds to each member 120, 130. Additionally, the rib 142A of the end member 130 is received in the groove 173A of the coupling member 172, and the ribs 128A of the body member 120 are received in the grooves 173B to mechanically secure the end member 130 and the body member 120 and provide strain relief against axial pullout of the components 130, 120 from the coupling member 172 or each other.

The insert section 159 of the lead end member 150 is inserted into the lead end 124 of the body member 120. The lead coupling member 176 is then formed (by injection molding using the mold apparatus 190, for example) and the lead end member 150 is secured to the body member 120 in the same manner as described above for the coupling member 172.

It will be appreciated from the description herein that the bonding between the coupling members 172, 176 and the adjacent components 120, 130, 150 will depend on the respective materials selected for the various components. According to some embodiments, the body member 120, the end members 130, 150 and the coupling members 172, 176 are each formed from a different or dissimilar polymeric material with each of the three materials belonging to the same class of polymeric materials, in which case some components (for example, the body member 120) may include an added flexibilizer. According to other embodiments, the body member 120, the end members 130, 150 and the coupling members 172, 176 are formed of three different polymeric materials.

According to some embodiments, the materials are selected as follows: the material of the body member 120 is selected from the group consisting of polyolefins, thermoplastic vulcanizates, thermoplastic elastomers, polyester, polyurethane, flexibilized polyamide, flexible poly(vinyl chloride), and polymers containing poly dimethyl siloxane; the material of the end member(s) 130, 150 is selected from the group consisting of polycarbonates, polyesters, glass reinforced polymers, polyolefins, acrylonitrile butadiene, styrene copolymers and alloys thereof, polyamides, liquid crystalline polymers, polyetherimide, polyphenylene sulfide, poly oxymethylene and copolymers thereof, poly ether ether ketone, polysulfone, and fluoropolymers; and the material of the coupling member(s) 172, 176 is selected from the group consisting of polymers containing polydimethyl siloxane, thermoplastic elastomers, thermoplastic vulcanizates, low density polyethylene, polyethylene block copolymers, polypropylene copolymers, and flexible poly(vinyl chloride).

According to some embodiments, the materials are selected as follows: the body member 120 is formed of polyolefin, polyethylene and/or polypropylene; the end member(s) 130, 150 is/are formed of polycarbonate/poly butylene terephthalate alloy and/or polyetherimide; and the coupling member(s) 172, 176 is/are formed of thermoplastic vulcanizate.

The protected cable assembly 10 (FIG. 1) may be assembled as follows. Before or after installing the connector 30 (if any), the cable 20 is trimmed to expose sections of the optical fiber 22 and the buffer tubes 28. With reference to FIG. 3, the cable connector member 180 is slid onto the cable 20 and the anchor section 187 is secured to the cable jacket 24 by adhesive 188 and heat shrink tubing 189. The cover 110 is slid over the optical fiber 22 and the cable connector member 180 such that the key tabs 186 seat in the slots 138. The clip 102 is then installed about the components 130, 180 and in the grooves 138A and 186A to lock the cover 110 onto the cable connector member 180. The O-ring 184A forms a water-proof seal between the cable connector member 180 and the end member 130 to thereby seal the chamber 104.

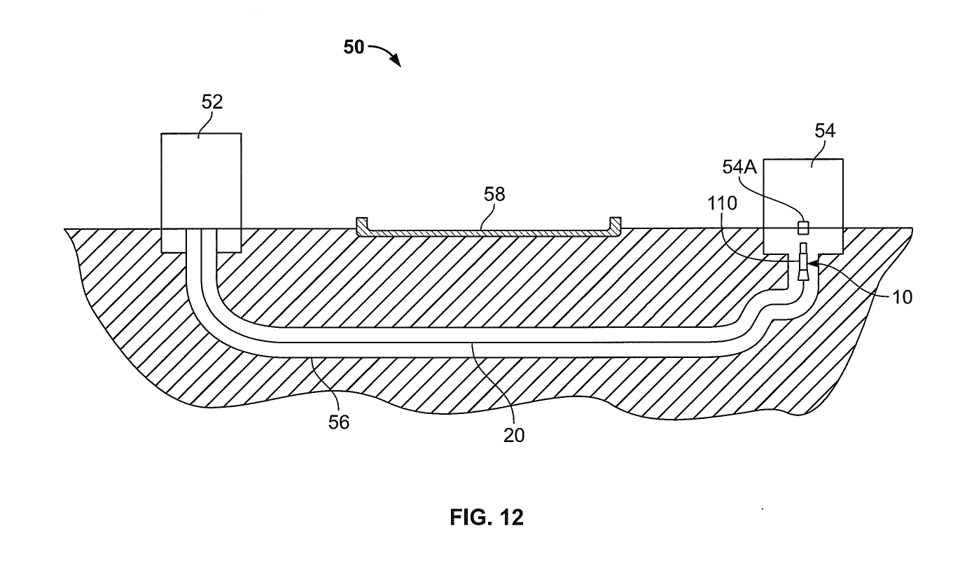

The protected cable assembly 10 may be deployed as follows. FIG. 12 illustrates an exemplary environment 50 wherein it may be desired or necessary to extend a fiber optic cable 20 from a first terminal 52 to a second, remote terminal 54. The installer may wish to route the cable through a subterranean conduit 56 under a road 58, for example. The installer can grasp the cover 110 and pull the cable 20 from the first terminal 52 to the second terminal 54 thereby. The enclosure assembly 100 will shield and protect the exposed fiber section 22B and the connector 30 from environmental hazards such as dirt, debris, moisture and abrasion. The lead end member 150 can be formed of a relatively hard material so that it can withstand impacts as it is drawn through the environment.

Once the end of the cable 20 bearing the enclosure assembly 100 is proximate the second terminal 54, the installer can remove the cover 110 by disengaging the clip 102. The optical fiber 22 and the connector 30 can then be connected or stored in the second terminal 54 as desired. According to some embodiments, the cable connector member 180 (which remains on the cable 20) is configured to operatively mechanically connect with a corresponding mating connector 54A on or in the second terminal 54. According to some embodiments, the second terminal 54 includes an environmentally protective cabinet, the connector 54A is in a port of the cabinet, and the connector member 180 and the connector 54A form an environmentally sealed (e.g., water-resistant or water-proof) connection when engaged.

The protected cable assembly 10 can be used in various legs of a fiber cable architecture. According to some embodiments, the first terminal 52 is a cabinet, handhole or the like within about 1500 meters of the second terminal 54, which is located on the premises of one or more subscribers, so that the cable 20 provides the to the premises leg of a fiber to the home (FTTH) or fiber to the business (FTTB) network. According to some embodiments, the first terminal 52 is within about 300 meters of the second terminal 54. For example, the cable 20 may extend from an optical network unit (ONU) in the cabinet or other enclosure of the first terminal 52 to a network interface device (NID) contained or embodied in the second terminal 54. Protected cable assemblies according to embodiments of the present invention may be employed in other fiber optic architectures or in different legs thereof. For example, the second terminal 54 may be a node or cabinet not on the premises of the subscriber(s), with the first terminal 52 being an upstream fiber optic terminal such as a central office or another outside plant (OSP) terminal.

The fiber optic enclosure assembly as disclosed herein can provide a number of advantages. The insert molded coupling members 172, 176 serve as filler materials enabling the provision of components of dissimilar materials in an integral, unitary cover 110. The tubular body member 120 can be constructed of a relatively flexible material to permit good bonding performance where needed. At the same time, the end members 130, 150 can be formed of a harder material and engineered to provide dimensionally stable features for coupling (e.g., with the body member 120 or the cable connector member 180), sealing, or other purposes (e.g., domed shape of the end member 150 to facilitate passage of the cable 20).

Insert molded coupling members 172, 176 can also serve to seal the joints between the end members 130, 150 and the body member 120 against ingress of water and other environmental contaminants.

Insert molding the end members 130, 150 together with the body member 120 using the coupling members 172, 176 also allows for relatively smooth inner and outer profiles at the joints as compared to, for example, methods such as heat shrink, mechanical coupler, or adhesive lap joint.

The protected cable assembly 10 can provide a pre-built (i.e., in a factory or shop), field deployable, protected cable system. According to some embodiments, the enclosure assembly 100, being flexible in body member 120, can be coiled along with the remainder of the cable 20.

Various types of coupling features may be provided to secure the base end member 130 and the cable connector member 180. For example, the clip 102 may be replaced or supplemented with holes, matches, keyways, grooves, internal or external threads or other features formed in the end member 130 and/or the cable connector member 180.

While an O-ring 184A is described herein for sealing the junction between the base end member 130 and the cable connector member 180, other suitable sealing mechanisms may be used, such as a gel seal.

The body member 120 may be formed with a different profile than described herein. For example, the body member 120 may be smooth walled.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A fiber optic enclosure assembly for protecting an optical fiber, the fiber optic enclosure assembly comprising:
a tubular body member having first and second opposed ends and defining an interior body passage to receive a portion of the optical fiber;
an end member separately formed from the body member and mounted on the first end thereof; and
a coupling member directly bonded to each of the body member and the end member to secure the end member to the body member and to form an environmental seal between the end member and the body member;
wherein the body member and the end member are formed of dissimilar materials, the material of the body member being more flexible than the material of the end member; and
wherein the coupling member is formed of a material capable of forming a secure bond with both the material of the body member and the material of the end member.

2. The fiber optic enclosure assembly of claim 1 wherein the body member, the end member, and the coupling member are formed of first, second and third dissimilar materials, respectively.

3. The fiber optic enclosure assembly of claim 2 wherein:
the material of the body member is selected from the group consisting of polyolefins, thermoplastic vulcanizates, thermoplastic elastomers, polyester, polyurethane, flexibilized polyamide, flexible poly(vinyl chloride), and polymers containing poly dimethyl siloxane;
the material of the end member is selected from the group consisting of polycarbonates, polyesters, glass reinforced polymers, polyolefins, acrylonitrile butadiene, styrene copolymers and alloys thereof, polyamides, liquid crystalline polymers, polyetherimide, polyphenylene sulfide, poly oxymethylene and copolymers thereof, polyether ether ketone, polysulfone, and fluoropolymers; and
the material of the coupling member is selected from the group consisting of polymers containing polydimethyl siloxane, thermoplastic elastomers, thermoplastic vulcanizates, low density polyethylene, polyethylene block copolymers, polypropylene copolymers, and flexible poly(vinyl chloride).

4. The fiber optic enclosure assembly of claim 3 wherein:
the body member is formed of polyolefin, polyethylene and/or polypropylene;
the end member is formed of polycarbonate/poly butylene terephthalate alloy and/or polyetherimide; and
the coupling member is formed of thermoplastic vulcanizate.

5. The fiber optic enclosure assembly of claim 1 wherein the coupling member is formed of a material including a bonding additive.

6. The fiber optic enclosure assembly of claim 1 wherein the end member includes an annular collar defining an entry passage to receive the optical fiber therethrough for entry into the interior body passage.

7. The fiber optic enclosure assembly of claim 6 wherein the end member includes a coupling feature configured to releasably mechanically couple the end member with a cable connector member.

8. The fiber optic enclosure assembly of claim 7 further including the cable connector member.

9. The fiber optic enclosure assembly of claim 6 wherein the end member is a first end member and further including:
a second end member separately formed from the body member and mounted on the second end thereof; and
a second coupling member directly bonded to each of the body member and the second end member to secure the second end member to the body member and to form an environmental seal between the second end member and the body member;
wherein the second end member serves as an end cap on the interior body passage of the body member to define a cavity closed on the second end.

10. The fiber optic enclosure assembly of claim 9 wherein the second end member has a generally dome-shaped outer surface.

11. The fiber optic enclosure assembly of claim 1 wherein at least one of the body member and the end member comprises a rib and/or a groove that engages the coupling member to provide mechanical strain relief therebetween.

12. The fiber optic enclosure assembly of claim 1 wherein the coupling member is directly chemically bonded to each of the body member and the end member.

13. A method for forming a fiber optic enclosure assembly for protecting an optical fiber, the method comprising:
providing a tubular body member having first and second opposed ends and defining an interior body passage to receive a portion of the optical fiber;
forming an end member separately from the body member;
mounting the end member on the first end of the body member; and
directly bonding a coupling member to each of the body member and the end member to secure the end member to the body member and to form an environmental seal between the end member and the body member;
wherein the body member and the end member are formed of dissimilar materials, the material of the body member being more flexible than the material of the end member; and
wherein the coupling member is formed of a material capable of forming a secure bond with both the material of the body member and the material of the end member.

14. The method of claim 13 wherein directly bonding the coupling member to each of the body member and the end member includes molding the coupling member directly onto each of the body member and the end member.

15. The method of claim 14 wherein directly bonding the coupling member to each of the body member and the end member includes injection insert molding the coupling member directly onto each of the body member and the end member.

16. The method of claim 13 wherein:
providing the body member includes extruding the body member; and
forming the end member includes molding and/or casting the end member.

17. The method of claim 13 wherein:
the body member is formed of polyolefin, polyethylene and/or polypropylene;
the end member is formed of polycarbonate/poly butylene terephthalate alloy and/or polyetherimide; and
the coupling member is formed of thermoplastic vulcanizate.

18. The method of claim 13 wherein the coupling member is formed of a material including a bonding additive.

19. The method of claim 13 wherein the end member is a first end member including an annular collar defining an entry passage to receive the optical fiber therethrough for entry into the interior body passage, and further including:
forming a second end member separately from the body member;
mounting the second end member on the second end of the body member; and
directly bonding a second coupling member to each of the body member and the second end member to secure the second end member to the body member and to form an environmental seal between the second end member and the body member;
wherein the second end member serves as an end cap on the interior body passage of the body member to define a cavity closed on the second end.

20. The method of claim 13 wherein directly bonding the coupling member to each of the body member and the end member includes directly chemically bonding the coupling member to each of the body member and the end member.

21. A method for deploying a fiber optic cable in an environment, the fiber optic cable including an optical fiber, the method comprising:
providing a fiber optic enclosure assembly including:
a tubular body member having first and second opposed ends and defining an interior body passage to receive a portion of the optical fiber;
an end member separately formed from the body member and mounted on the first end thereof; and
a coupling member directly bonded to each of the body member and the end member to secure the end member to the body member and to form an environmental seal between the end member and the body member;
wherein the body member and the end member are formed of dissimilar materials, the material of the body member being more flexible than the material of the end member; and
wherein the coupling member is formed of a material capable of forming a secure bond with both the material of the body member and the material of the end member;
installing the fiber optic enclosure assembly on the fiber optic cable such that a portion of the optical fiber is disposed in the interior body passage; and
pulling the fiber optic enclosure assembly to draw the fiber optic cable through the environment.

22. The method of claim 21 including removing the body member, the end member and the coupling member from the fiber optic cable following the step of pulling the fiber optic enclosure assembly to draw the fiber optic cable through the environment.

23. The method of claim 21 wherein the coupling member is directly chemically bonded to each of the body member and the end member.
